(19) United States
(12) Patent Application Publication
(10) Pub. No.: US 2015/0324883 A1
(43) Pub. Date: Nov. 12, 2015

(54) ITEM TAGGING

(71) Applicant: PAYPAL, INC., San Jose, CA (US)

(72) Inventor: Lucy Ma Zhao, Austin, TX (US)

(21) Appl. No.: 14/804,189

(22) Filed: Jul. 20, 2015

Related U.S. Application Data
(63) Continuation of application No. 13/603,594, filed on Sep. 5, 2012.

(51) Int. Cl. G06Q 30/06

(52) U.S. Cl. CPC G06Q 30/0613; G06Q 30/0641

(57) ABSTRACT

Systems and methods for facilitating the purchase of tagged items for a friend are described. The methods include receiving a communication with a link to one or more items tagged by a first user for a second user, transmitting the communication to a user device of the second user, receiving a payment request in connection with the one or more tagged items from the user device, and processing the payment request.

### CROSS-REFERENCE TO RELATED APPLICATION

This application is a continuation of and claims priority to U.S. patent application Ser. No. 13/603,594, filed Sep. 5, 2012, which is incorporated herein by reference in its entirety.

### BACKGROUND

1. Technical Field

Embodiments of the present invention generally relate to commerce using a communication network such as the Internet and, more particularly, to providing users, through a service provider, a convenient way to share information about products and services that has advantages for both shoppers and merchants.

2. Related Art

In electronic commerce, a customer routinely searches for, purchases and pays for products and/or services from online merchants over communication networks, such as the Internet. In a generally familiar process of online commerce, also referred to as e-commerce or online shopping, a consumer, using a mobile phone or computing device, may find an item of interest either directly by visiting the website of a retailer or indirectly by searching among alternative vendors using a shopping search engine. However, typical ways of conducting transactions over the Internet may be cumbersome and inconvenient. For example, when searching for an item over the Internet, if the right keywords are not searched, the customer may not find the item that the customer is potentially interested in purchasing. A user may find an item for a friend, but may have trouble sending a link of the item to the friend without knowing the friend's email address. Accordingly, there is a need for a more convenient way of conducting transactions.

### BRIEF DESCRIPTION OF THE FIGURES

FIG. 1 is a block diagram illustrating a system for tagging items according to an embodiment of the present disclosure.

FIG. 2 is a flow diagram illustrating a method for tagging items according to an embodiment of the present disclosure.

FIG. 3 is a block diagram of a system for implementing a device according to one embodiment of the present disclosure.

Like element numbers in different figures represent the same or similar elements.

### DETAILED DESCRIPTION

In accordance with various embodiments described herein, methods and systems are provided for facilitating financial transactions. In an embodiment, a feature may be incorporated into a web browser that allows a user to tag a product or service for a friend. When the user or customer is searching for products or services (“items”) online over a network via a user device (e.g., a mobile device or any other user device such as a personal computer), the user can “tag,” i.e., label or identify, an item for a friend who the user thinks may be interested in the item. Upon tagging the item, a link with the item is sent to the friend. The friend can open the link, view the item, and decide whether or not to purchase the item. Transactions can take place with the aid of a service provider such as PayPal® and/or eBay®, Inc. of San Jose, Calif. If the friend decides to purchase the item, the service provider receives and processes payment.

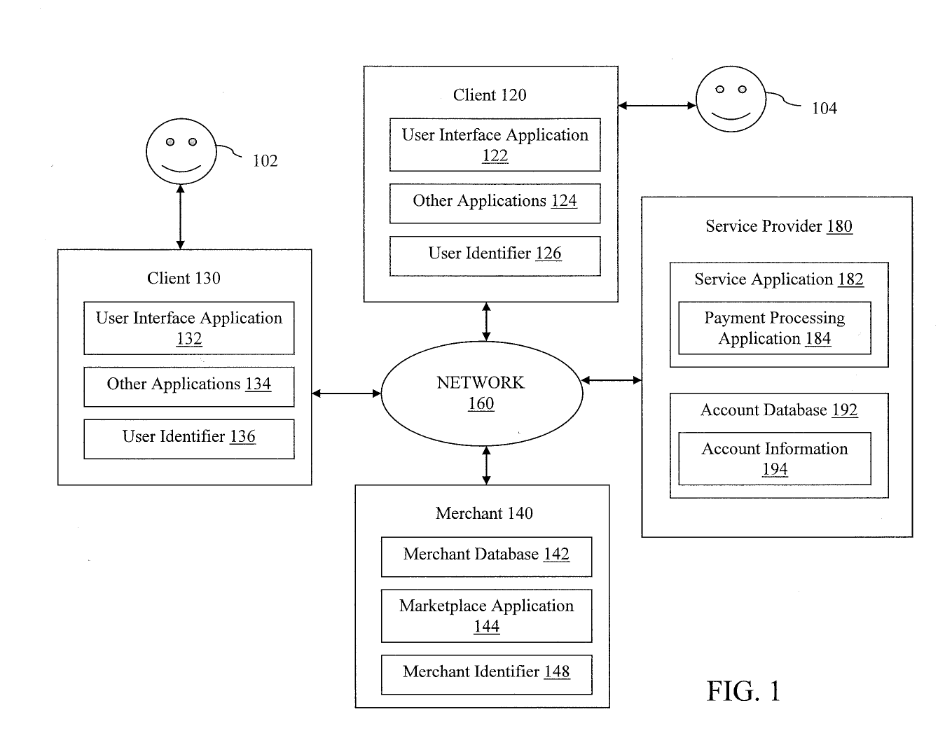

Referring now to the drawings wherein the showings are for purposes of illustrating embodiments of the present disclosure only, and not for purposes of limiting the same, FIG. 1 illustrates a block diagram of a system for tagging items for a friend according to an embodiment of the present disclosure.

FIG. 1 shows one embodiment of a block diagram of a system 100 adapted to facilitate item tagging using a first client device 120 over a network 160. As shown in FIG. 1, the system 100 includes first client device 120 (e.g., network computing device), second client device 130, one or more merchant servers or devices 140 (e.g., network server devices), and at least one service provider server or device 180 (e.g., network server device) in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, first client device 120, second client device 130, merchant servers or devices 140, and service provider server or device 180 may be associated with a particular link (e.g., a link, such as a URL (Uniform Resource Locator) to an IP (Internet Protocol) address).

The first client device 120 and second client device 130, in various embodiments, may be implemented using any appropriate combination of hardware and/or software configured for wired and/or wireless communication over the network 160. In various examples, first client device 120 may be implemented as a wireless telephone (e.g., cellular or mobile phone), a tablet, a personal digital assistant (PDA), a personal computer, a notebook computer, and/or various other generally known types of wired and/or wireless computing devices. It should be appreciated that first client device 120 may be referred to as a user device or a customer device without departing from the scope of the present disclosure.

The first client device 120, in one embodiment, includes a user interface application 122, which may be utilized by the sender 102 to conduct transactions (e.g., shopping, purchasing, bidding, etc.) with the merchant server or device 140 or with the service provider server 180 over the network 160. In one aspect, purchase expenses may be directly and/or automatically debited from an account related to the sender 102 via the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160. The web browser includes a feature that allows sender 102 to tag an item for recipient 104. Tagging software can be added to existing software suites with relative ease. The web browser may be any application that is used to search for and display content on a distributed data processing system. Suitable browsers include Netscape Navigator, Microsoft Internet Explorer, Mozilla Firefox, and Google Chrome.

In one embodiment, the web browser includes a right click browser feature that allows sender 102 to select recipient 104 from a contact list when sender 102 right clicks the mouse. Sender 102 can import contacts from his or her social networks, such as contacts in the sender's email address book, friends on Facebook®, connections on LinkedIn®, contacts on Flickr®, followers on Twitter®, and people in the sender's circle in Google+®. In various embodiments, the browser can be preconfigured by sender 102 so that alerts with links to the tagged item are sent to recipient 104 in the form of emails or text messages. Sender 102 does not need to know recipient's 104 contact information, e.g., email address or phone number, to send the link, but can tag items for friends on his or her social networks. Sender 102 may also set up other preferences for his or her web browsing session.

In another example, the sender 102 and recipient 104 are able to access merchant websites via the one or more merchant servers 140 to view and select items for purchase, and the sender 102 and/or recipient 104 are able to purchase items from the one or more merchant servers 140 via the service provider server 180. Accordingly, in one or more embodiments, the sender 102 and/or recipient 104 may conduct transactions (e.g., purchase and provide payment for one or more items) from the one or more merchant servers 140 via the service provider server 180.

The first client device 120, in various embodiments, may include other applications 124 as may be desired in one or more embodiments of the present disclosure to provide additional features available to sender 102. In one example, such other applications 124 may include security applications for implementing client-side security features, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

The first client device 120, in one embodiment, may include at least one user identifier 126, which may be implemented, for example, as operating system registry entries, cookies associated with the user interface application 122, identifiers associated with hardware of the client device 120, or various other appropriate identifiers. The user identifier 126 may include one or more attributes related to the sender 102, such as personal information related to the sender 102 (e.g., one or more user names, passwords, photograph images, biometric IDs, addresses, phone numbers, etc.) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the sender 102 with a particular user account maintained by the service provider server 180.

Second client device 130 may have similar applications and modules as first client device 120, but is used, in this example, for receiving messages, emails, texts, and other communication sent by sender 102 via the first client device 120 and conducting financial transactions (e.g., purchase and provide payment for one or more items) from the one or more merchant servers 140 via the service provider server 180. Second client device 130 may also include a user interface application 132 and one or more other applications 134 which may be used, for example, to provide a convenient interface to permit recipient 104 to browse information and perform tasks over network 160. For example, in one embodiment, user interface application 132 may be implemented as a web browser configured to view information available over the Internet and communicate with service provider server 180 to receive and send information about payment based on a message from sender 102.

Second client device 130 may further include other applications 134 such as security applications for implementing client-side security features, programmatic client applications for interfacing with appropriate application programming interfaces (APIs) over network 160, or other types of applications. Applications 134 may also include email, text, IM, and voice applications that allow recipient 104 to communicate through network 160, receive messages from sender 102, and create and manage funding sources. Second client device 140 includes one or more user identifiers 136 which may be implemented, for example, as operating system registry entries, cookies associated with user interface application 132, identifiers associated with hardware of second client device 130, or other appropriate identifiers, such as used for payment/recipient/device authentication, e.g., the phone number associated with second client device 130. Identifiers may be used by a service provider to associate recipient 104 with a particular account maintained by the service provider.

The one or more merchant servers 140, in various embodiments, may be maintained by one or more business entities (or in some cases, by a partner of a business entity that processes transactions on behalf of business entities). Examples of businesses entities include merchant sites, resource information sites, utility sites, real estate management sites, social networking sites, etc., which offer various items for purchase and payment. In some embodiments, business entities may need registration of the user identity information as part of offering the items to the sender 102 and recipient 104 over the network 160. As such, each of the one or more merchant servers 140 may include a merchant database 142 for identifying available items, which may be made available to the first client device 120 and/or the second client device 130 for viewing and purchase by the sender 102 and/or recipient 104. In one or more embodiments, sender 102 and/or recipient 104 may complete a transaction such as purchasing the items via service provider server 180.

Each of the merchant servers 140, in one embodiment, may include a marketplace application 144, which may be configured to provide information over the network 160 to the user interface applications 122, 132 of first client device 120 and second client device 130. For example, sender 102 may interact with the marketplace application 144 through the user interface application 122 over the network 160 to search and view various items available for purchase in the merchant database 142.

Each of the merchant servers 140, in one embodiment, may include at least one merchant identifier 148, which may be included as part of the one or more items made available for purchase so that, e.g., particular items are associated with particular merchants. In one implementation, the merchant identifier 148 may include one or more attributes and/or parameters related to the merchant, such as business and banking information. In various embodiments, sender 102 and/or recipient 104 may conduct transactions (e.g., searching, selection, monitoring, purchasing, and/or providing payment for items) with each merchant server 140 via the service provider server 180 over the network 160.

A merchant website may also communicate (for example, using merchant server 140) with the service provider through service provider server 180 over network 160. For example, the merchant website may communicate with the service provider in the course of various services offered by the service provider to merchant website, such as payment intermediary between customers (e.g., sender 102 and recipient 104) of the merchant website and the merchant website itself. For example, the merchant website may use an application programming interface (API) that allows it to offer sale of goods in which customers are allowed to make payment through the service provider, while sender 102 and/or recipient 104 may have an account with the service provider that allows sender 102 and/or recipient 104 to use the service provider for making payments to merchants that allow use of authentication, authorization, and payment services of service provider as a payment intermediary. The merchant website may also have an account with the service provider.

The service provider server 180, in one embodiment, may be maintained by a transaction processing entity, which may provide processing for financial transactions and/or information transactions between the sender 102, recipient 104, and one or more of the merchant servers 140. As such, the service provider server 180 includes a service application 182, which may be adapted to interact with each client device 120, 130 and/or each merchant server 140 over the network 160 to facilitate the searching, selection, purchase, and/or payment of items by the user 102 and/or recipient 104 from one or more of the merchant servers 140. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 182, in one embodiment, utilizes a payment processing module 184 to process purchases and/or payments for financial transactions between the sender 102, recipient 104, and each of the merchant servers 140. In one implementation, the payment processing module 184 assists with resolving financial transactions through validation, delivery, and settlement. As such, the service application 182 in conjunction with the payment processing module 184 settles indebtedness between the sender 102, recipient 104, and each of the merchants 140, wherein accounts may be directly and/or automatically debited and/or credited of monetary funds in a manner as accepted by the banking industry.

The service provider server 180, in one embodiment, may be configured to maintain one or more user accounts and merchant accounts in an account database 192, each of which may include account information 194 associated with one or more individual users (e.g., sender 102 and recipient 104) and merchants (e.g., one or more merchants associated with merchant servers 140). For example, account information 194 may include private financial information of each user 102, 104 and each merchant associated with the one or more merchant servers 140, such as one or more account numbers, passwords, credit card information, banking information, or other types of financial information, which may be used to facilitate financial transactions between sender 102, recipient 104, and the one or more merchants associated with the merchant servers 140. In various aspects, the methods and systems described herein may be modified to accommodate users and/or merchants that may or may not be associated with at least one existing user account and/or merchant account, respectively.

In one implementation, the sender 102 and/or recipient 104 may have identity attributes stored with the service provider server 180, and sender 102 and/or user 104 may have credentials to authenticate or verify identity with the service provider server 180. User attributes may include personal information, banking information and/or funding sources as previously described. In various aspects, the user attributes may be passed to the service provider server 180 as part of a login, search, selection, purchase, and/or payment request, and the user attributes may be utilized by the service provider server 180 to associate sender 102 and/or recipient 104 with one or more particular user accounts maintained by the service provider server 180.

The system described above with respect to the embodiment of FIG. 1 may be used for item tagging such that when sender 102 searches for one or more items online and finds an item suitable for recipient 104, for example, on one or more websites hosted by merchant servers 140, a link with the item can be sent and received by recipient 104. Recipient 104 can then open the link, view the item, and pay for the item through the service provider.

For example, assume Mary sees a pair of shoes at an online store that she thinks would go perfect with her sister Ann's new dress. In her browser, Mary right clicks on the page and selects “Tag Product for Friend” from the menu. Mary selects Ann's name from the list that populates. When Ann logs in the next day, she sees an alert for a new tagged item for her from Mary. Ann clicks on the link and is taken to the webpage that has the shoes. Ann really likes the shoes and decides to pay for them using her PayPal® account.

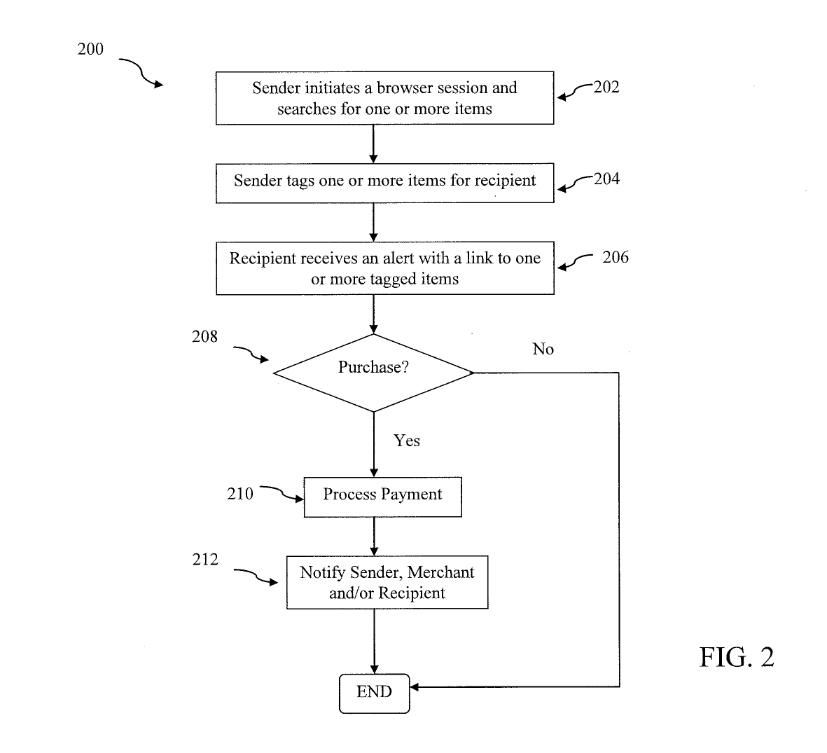

Referring now to FIG. 2, a flow diagram of a method 200 for item tagging is illustrated according to an embodiment of the present disclosure. It should be appreciated that the method illustrated in the embodiment of FIG. 2 may be implemented by the system illustrated in FIG. 1 according to one or more embodiments.

In an embodiment, at step 202, sender 102 initiates a browser session, browses a website hosted by merchant server 140, and searches online for one or more particular items. For example, sender 102 may search for particular items online using his or her personal computer, tablet, mobile device or any other user device having a web browser with the tagging feature. A desired item may be one that sender 102 specifically searches for, such as by entering a specific search term or item description, one that sender 102 places in a cart but does not purchase, one that sender 102 requests details on such as accessing a URL or site describing the item, or other indicators of interest. The sender 102 can optionally preconfigure the browser session before initiating the search.

Sender 102 may find an item and decide that someone else, such as a friend or family member, e.g., a contact on a social networking website, may like the item. In step 204, sender 102 labels or “tags” the item for a recipient, e.g., recipient 104. In one embodiment, sender 102 enters or otherwise selects or tags recipient 104 from a contact list. Sender 102 does not need to type in the email address or phone number of recipient 104, but merely selects recipient 104's name from a list. The contact list may be imported from sender 102's email contact list, friends on Facebook®, or any other social networking sites. In another embodiment, the web browser is configured such that when sender 102 right clicks the mouse, sender 102 is given the option to select a friend from a list. In one embodiment, the contact list may be customized such that right clicking the mouse provides certain categories of friends, and sender 102 clicks on the desired category to view an additional layer of friends.

The tag may be linked to a resource, such as a webpage associated with the item. In step 206, recipient 104 receives an alert or other notification with a link to the item on the merchant's website. Examples of alerts include an icon on a display, text message, an email, etc. In one embodiment, when recipient 104 logs in to an application, such as one provided by a service provider such as PayPal® and/or eBay®, Inc. of San Jose, Calif., recipient 104 sees the alert. When recipient 104 clicks on the link within the alert, he or she can view the item.

In one or more embodiments, recipient 104 may decide to complete the transaction such as make payment via his or her account with a service provider (e.g., service provider server 180 of FIG. 1). In that regard, recipient 104 may have a pre-existing account with service provider server 180 wherein recipient 104 has identity attributes stored with service provider server 180 as described above. Once recipient 104 decides to purchase and pay for the item, service provider server 180 may be used to effect the payment. In other embodiments, recipient 104 may choose cash or a specific transaction card as a funding source to complete payment and finalize the transaction.

In step 208, if recipient 104 decides to purchase the item, the method proceeds, and this is communicated electronically to the merchant or service provider from the second client device 130. For example, recipient 104 may place the desired item in a cart, enter payment information, such as funding source and related information, a shopping option, any message, and a confirmation of the purchase, such as through a click, tap, or other means of selection.

In step 210, the purchase is processed by the service provider, which may include crediting an account of the merchant and debiting an account of recipient 104. Processing may also require authenticating recipient 104 if needed, such as by requesting a PIN or password from recipient 104, including any identifying information, such as user name.

After the purchase is processed, in step 212, recipient 104, sender 102, and/or the merchant may be notified, such as by the service provider. If the purchase is declined, recipient 104 and the merchant may be notified, and recipient 104 may try another funding source or option.

If the purchase is approved, all three parties may be notified. The merchant may then deliver the purchased item to recipient 104.

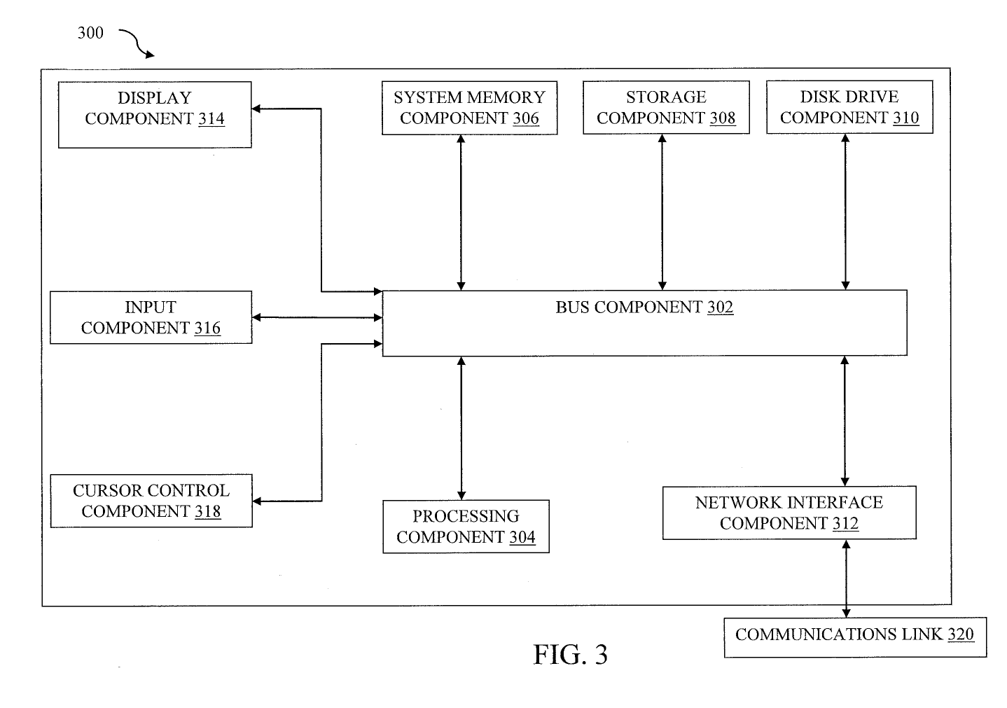

Referring now to FIG. 3, a block diagram of a system 300 is illustrated suitable for implementing embodiments of the present disclosure, including first client device 120, second client device 130, one or more merchant servers or devices 140, and service provider server or device 180. System 300, such as part of a cell phone, a tablet, a personal computer and/or a network server, includes a bus 302 or other communication mechanism for communicating information, which interconnects subsystems and components, including one or more of a processing component 304 (e.g., processor, micro-controller, digital signal processor (DSP), etc.), a system memory component 306 (e.g., RAM), a static storage component 308 (e.g., ROM), a network interface component 312, a display component 314 (or alternatively, an interface to an external display), an input component 316 (e.g., keypad or keyboard), and a cursor control component 318 (e.g., a mouse pad).

In accordance with embodiments of the present disclosure, system 300 performs specific operations by processor 304 executing one or more sequences of one or more instructions contained in system memory component 306. Such instructions may be read into system memory component 306 from another computer readable medium, such as static storage component 308. These may include instructions to send and receive communications with links for tagged items, process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 304 for execution. Such a medium may take many forms, including but not limited to, non-volatile media, volatile media, and transmission media. In various implementations, volatile media includes dynamic memory, such as system memory component 306, and transmission media includes coaxial cables, copper wire, and fiber optics, including wires that comprise bus 302. Memory may be used to store visual representations of the different options for searching, auto-synchronizing, making payments or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 300. In various other embodiments, a plurality of systems 300 coupled by communication link 320 (e.g., network 160 of FIG. 1, LAN, WLAN, PTSN, or various other wired or wireless networks) may perform instruction sequences to practice the disclosure in coordination with one another. Computer system 300 may transmit and receive messages, data, information and instructions, including one or more programs (i.e., application code) through communication link 320 and communication interface 312. Received program code may be executed by processor 304 as received and/or stored in disk drive component 310 or some other non-volatile storage component for execution.

In view of the present disclosure, it will be appreciated that various methods and systems have been described according to one or more embodiments for facilitating the purchase of tagged items for friends.

Although various components and steps have been described herein as being associated with first client device 120, second client device 130, merchant server 140, and service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure. For example, although merchant transactions have been described according to one or more embodiments, it should be understood that the present disclosure may also apply to transactions where requests for information, requests for access, or requests to perform certain other transactions may be involved.

Having thus described embodiments of the disclosure, persons of ordinary skill in the art will recognize that changes may be made in form and detail without departing from the scope of the disclosure. Thus the disclosure is limited only by the claims.

What is claimed is:

1. A method for displaying an item on a user interface comprising:
receiving a user action on a first electronic user interface page where a merchant directly offers an item for sale;
in response to receiving the user action, presenting, on the first electronic user interface page, a contact list;
detecting a user selection at the first electronic user interface page of a contact from the contact list; and
in response to the detecting, causing a link to be transmitted to the selected contact, the link being configured to be selectable by the selected contact to cause presentation of the item to the selected contact via a second electronic user interface page.

2. The method of claim 1, wherein the user action comprises a right click.

3. The method of claim 1, wherein the first electronic user interface page comprises a webpage.

4. The method of claim 1, further comprising:
receiving a payment request for the item from the selected contact; and
processing the payment request.

5. The method of claim 4, further comprising notifying a user and the selected contact that the payment request was processed, and wherein the link is transmitted without the user inputting contact information of the selected contact.

6. The method of claim 1, further comprising:
receiving log in information on the second electronic user interface page from the selected contact; and
in response to receiving the log in information, presenting, on the second electronic user interface page, the link.

7. The method of claim 1, wherein a user and the selected contact are connected on at least one social networking website, and the link is transmitted in the form of a text message or email.

8. A system for displaying an item on a user interface, comprising:
a memory device; and
one or more processors configured to read instructions from the memory and configured to cause the system to:
receive a user cursor action on a first electronic user interface page where a merchant directly offers one or more items for sale;
in response to receiving the user cursor action, presenting, on the first electronic user interface page, a menu;
detect a user selection at the first electronic user interface page of a contact from the menu; and
in response to the detecting, causing a link to be transmitted to the selected contact, the link being configured to be selectable by the selected contact to cause presentation of the one or more items to the selected contact via a second electronic user interface page.

9. The system of claim 8, wherein the user cursor action comprises a right click.

10. The system of claim 8, wherein the first electronic user interface comprises a webpage.

11. The system of claim 8, wherein the menu comprises a contact list.

12. The system of claim 8, wherein the one or more processors are further configured to cause the system to:
receive a payment request for the one or more items from the selected contact; and
process the payment request.

13. The system of claim 12, wherein the one or more processors are further configured to cause the system to notify a user and the selected contact that the payment request was processed, and wherein the link is transmitted without the user inputting contact information of the selected contact.

14. The system of claim 8, wherein the one or more processors are further configured to cause the system to:
receive log in information on the second electronic user interface page from the selected contact; and
in response to receiving the log in information, present, on the second electronic user interface page, the link.

15. A non-transitory machine-readable medium comprising a plurality of machine-readable instructions that are executable by a machine to cause the machine to perform operations comprising:
receiving a user action on a merchant webpage where a merchant directly offers an item for sale;
in response to receiving the user action, presenting, on the merchant webpage, a menu;
detecting a user selection at the merchant webpage of a contact from the menu; and
in response to the detecting, causing a link to be transmitted to the selected contact, the link being configured to be selectable by the selected contact to cause presentation of the item to the selected contact via a service provider webpage.

16. The non-transitory machine-readable medium of claim 15, wherein the user action comprises a right click.

17. The non-transitory machine-readable medium of claim 15, wherein the menu comprises a contact list.

18. The non-transitory machine-readable medium of claim 15, wherein the operations further comprise:
receiving a payment request for the item from the selected contact; and
processing the payment request.

19. The non-transitory machine-readable medium of claim 18, wherein the operations further comprise notifying a user and the selected contact that the payment request was processed, and wherein the link is transmitted without the user inputting contact information of the selected contact.

20. The non-transitory machine-readable medium of claim 15, wherein the operations further comprise:
receiving log in information on the service provider webpage from the selected contact; and
in response to receiving the log in information, presenting, on the service provider webpage, the link.
